(19) United States
(12) Patent Application Publication
(10) Pub. No.: US 2008/0307976 A1
(43) Pub. Date: Dec. 18, 2008

(54) ELECTRIC GRILL WITH SKEWER HOLDERS

(76) Inventor: Yu-Yuan Lin, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/762,145

(22) Filed: Jun. 13, 2007

(51) Int. Cl. A47J 36/00; A47J 37/06

(52) U.S. Cl. 99/337

(57) ABSTRACT

An electric grill with skewer holders has a first grill plate and a second grill plate for roasting various foods. Each of the first and second grill plates has at least one side wall formed with a plurality of concave portions so that a plurality of skewers skewered with foodstuffs can be positioned in a plurality of holes defined by the concave portions and holding ends of the skewers can be exposed out of the electric grill for preventing the holding ends from being heated by the high temperature in the electric grill and stained with oil leaked from the foodstuffs sandwiched between the grill plates so that the skewers can be conveniently held by hand without burning and staining hands with oil.

### FIELD OF THE INVENTION

The present invention relates to an electric grill with skewer holders, and more particularly to an electric grill provided with a plurality of concave portions formed on at least one side wall of first and second grill plates for roasting foods, so that skewers skewered with foodstuffs can be conveniently held without burning one's hand.

### BACKGROUND OF THE INVENTION

Presently, a traditional electric grill for roasting foods generally comprises a first grill plate, a second grill plate pivotally connected to the first grill plate, and an electric heater mounted in the first and second grill plates for heating foods sandwiched between the first and second grill plates. Before manually roasting various foods, such as shrimps, chicken wings, tempuras, mushrooms, or vegetables, the foods are generally skewered by bamboo skewers for being conveniently held by a user's hand to enjoy the foods. When roasting, the bamboo skewer skewered with the foods is suitably sandwiched between the first and second grill plates for heating the foods. However, after roasting, a holding end of the bamboo skewer is inevitably heated and stained with oil leaked from the heated foods, because the holding end is also sandwiched between the first and second grill plates. As a result, the user can not directly hold the holding end of the bamboo skewer by hand, but only can indirectly hold the bamboo skewer by other auxiliaries, such as a clip and etc. After this, the user must hold the holding end of the bamboo skewer by a paper to prevent his/her hand from being burned or stained with oil, because the holding end is still hot and stained with oil. Alternatively, the user may firstly put the foods in the traditional electric grill for roasting, and then take the heated foods off the traditional electric grill for skewering the heated foods in a bamboo skewer, so as to prevent the foregoing problem that the holding end is heated and stained with oil due to being sandwiched between the first and second grill plates. However, the foods skewered after roasting appear to be relatively not delicious and sanitary.

### SUMMARY OF THE INVENTION

It is therefore tried by the inventor to develop an electric grill with skewer holders to solve the problems existing in the traditional electric grill that is used to roast various foods skewered by bamboo skewers but the holding ends of the bamboo skewers is easily heated and stained with oil due to being sandwiched between the first and second grill plates resulting in causing the inconveniently holding shortcoming, as described above, wherein when roasting, a holding end of the bamboo skewer can be exposed out of the electric grill according to the present invention and can be directly held by hand after roasting, i.e. the electric grill of the present invention prevents the holding end of the bamboo skewer skewered with foodstuffs from being heated by the high temperature in the electric grill or stained with oil leaked from the foodstuffs when roasting.

A primary object of the present invention is to provide an electric grill with skewer holders, comprising a first grill plate and a second grill plate for roasting foods. Each of the first and second grill plates has at least one side wall formed with a plurality of concave portions, so that a plurality of skewers skewered with foodstuffs can be positioned in a plurality of holes defined by the concave portions and a holding end of each of the skewers can be exposed out of the first and second grill plates for conveniently holding the skewers skewered with the foodstuffs without burning one's hand.

A secondary object of the present invention is that the concave portions formed on the at least one side walls of the first and second grill plates can be shaped in a wavy configuration so that the concave portions of the first grill plate are matched with the concave portions of the second grill plate, so as to commonly define a plurality of holes for allowing the holding ends of the skewers skewered with foodstuffs to pass through and extend out of the electric grill, for the purpose of preventing the holding ends of the skewers from being heated or stained with oil leaked from the foods when the first and second grill plates heat the foods skewered by the skewers.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of an electric grill in a closed status according to a preferred embodiment of the present invention;

FIG. 2 is an operational view of the electric grill in an open status for disposing a plurality of skewers skewered with foods on one of a first grill plate and a second grill plate according to the preferred embodiment of the present invention;

FIG. 3 is a side view of the electric grill showing a plurality of concave portions formed on at least one side wall of the first and second grill plates before the first and second grill plates are closed according to the preferred embodiment of the present invention; and

FIG. 4 is a side view of the electric grill showing the concave portions on the side wall of the first and second grill plates after the first and second grill plates are closed according to the preferred embodiment of the present invention.

### DETAILED DESCRIPTION OF THE PREFERRED EMBODIMENTS

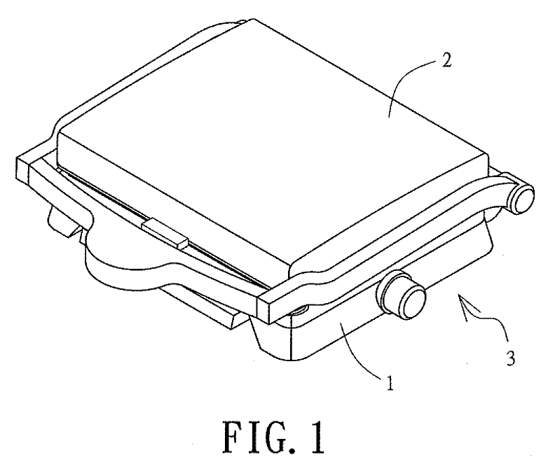

Referring now to FIG. 1, an electric grill with skewer holders according to a preferred embodiment of the present invention is illustrated. As shown, the electric grill designated by numeral 3 comprises a first grill plate 1 and a second grill plate 2 pivotally connected to the first grill plate 1.

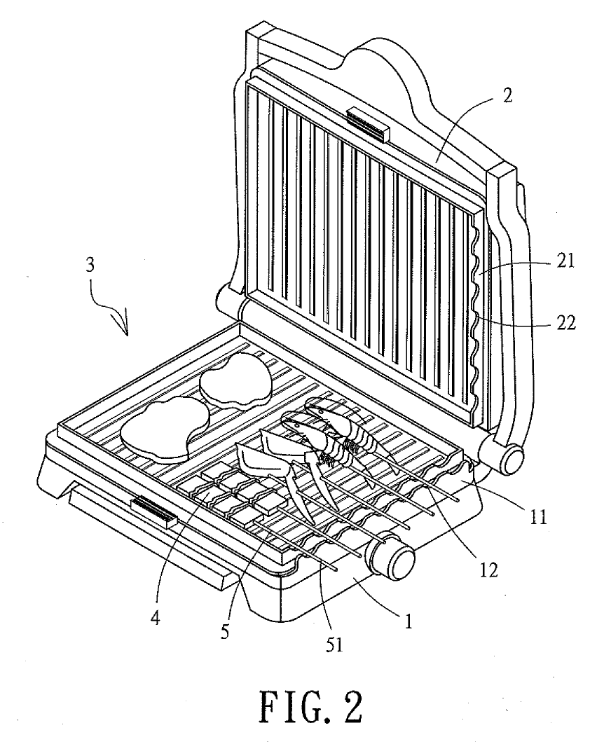

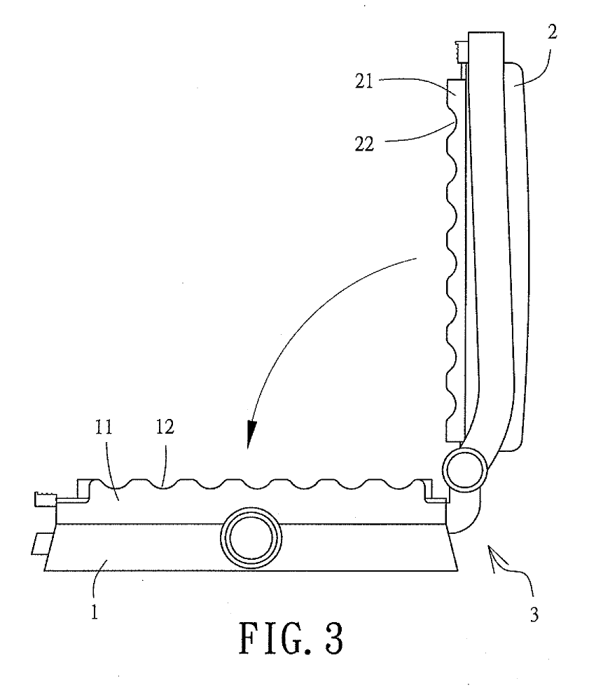

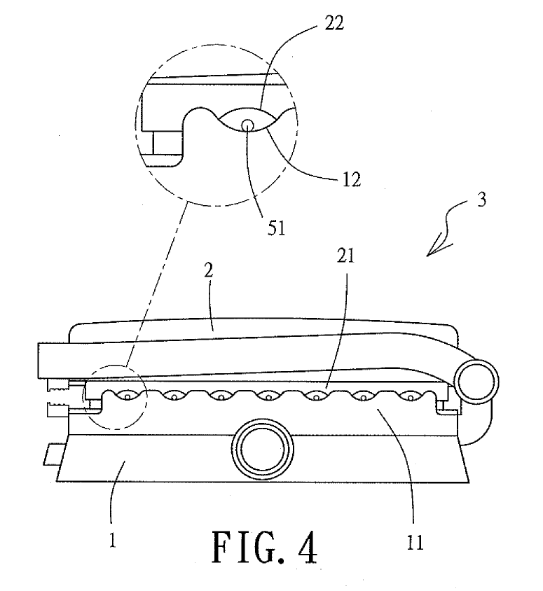

The first grill plate 1 is provided with two first side walls 11, and at least one of the first side walls 11 is formed with a plurality of first concave portions 12. Meanwhile, the second grill plate 2 is provided with two second side walls 21, and at least one of the second side walls 21 is formed with a plurality of second concave portions 22. In the preferred embodiment of the present invention, only one of the first side walls 11 is formed with the first concave portions 12, and only one of the second side walls 12 is formed with the second concave portions 22, as shown in FIG. 2. In an alternatively preferred embodiment of the present invention, both of the first side walls 11 can be formed with the first concave portions 12, and both of the second side walls 12 can be formed with the second concave portions 22. Referring now to FIG. 2, in the preferred embodiment of the present invention, when the electric grill 3 is used to roast various foodstuffs 4, the foodstuffs 4 can be skewered together by a plurality of bamboo skewers 5, each of which has a holding end 51. The bamboo skewers 5 can be positioned in the first concave portions 12 of the first side wall 11 of the first grill plate 1, so that the holding ends 51 thereof are exposed out of the first side wall 11 of the first grill plate 1. After this, the second grill plate 2 is correspondingly covered upon the first grill plate 1, as shown in FIGS. 3 and 4, and the first concave portions 12 of the first side wall 11 of the first grill plate 1 are matched with the second concave portions 22 of the second side wall 12 of the second grill plate 2, so as to commonly define a plurality of holes (unlabeled) for skewers 5. As a result, the holding ends 51 of the bamboo skewers 5 skewered with foodstuffs 4 pass through the holes, and extend out of the first side wall 11 of the first grill plate 1 and the second side wall 12 of the second grill plate 2. Therefore, the holding ends 51 of the bamboo skewers 5 are prevented from being heated by the high temperature within the electric grill 3 and stained with oil leaked from the foodstuffs 4 sandwiched between the first grill plate 1 and the second grill plate 2. After roasting, the holding ends 51 can maintain an unheated and clean appearance for being conveniently held by hand without burning and staining hands with oil.

Referring still to FIG. 3, in the preferred embodiment of the present invention, the first concave portions 12 of the at least one first side wall 11 of the first grill plate 1 and the second concave portions 22 of the at least one second side wall 21 of the second grill plate 2 are preferably shaped in a wavy configuration or other equivalent configurations, so as to commonly define the holes for the holding ends 51 of the bamboo skewers 5 skewered with foodstuffs 4 to pass through and extend out of the electric grill 3, as shown in FIG. 4, for the purpose of preventing the holding ends 51 from being heated by the high temperature in the electric grill 3 and stained with oil leaked from the foodstuffs 4.

As described above, the electric grill 3 according to the preferred embodiment of the present invention can be used to roast the foodstuffs 4 skewered by the bamboo skewers 5, while providing the following advantages:

1. The holding ends of the bamboo skewers skewered with foodstuffs can be supported by and pass through the concave portions of the side walls of the grill plates, and extend out of the grill plates, so as to maintain the holding ends of the bamboo skewers an unheated and clean appearance for being conveniently held by hand without burning and staining hands with oil.

2. The concave portions of the side walls of the grill plates can be shaped in various configurations, such as the wavy configuration, so as to commonly define the holes for skewers with various configurations, for receiving the holding ends of the bamboo skewers with various configurations.

The present invention has been described with a preferred embodiment thereof and it is understood that many changes and modifications to the described embodiment can be carried out without departing from the scope and the spirit of the invention that is intended to be limited only by the appended claims.

What is claimed is:

1. An electric grill with skewer holders, comprising a first grill plate and a second grill plate pivotally connected to the first grill plate, characterized in that:
each of the first and second grill plates for roasting food has one side wall formed with a plurality of concave portions so that a plurality of skewers skewered with foodstuffs can be positioned in holes defined by the concave portions and a holding end of each of the skewers is exposed out of the side walls, hereby the holding end of the bamboo skewer is maintained with an unheated and clean appearance for being conveniently held by hand without burning hands.

2. The electric grill with the skewer holders of claim 1, wherein the concave portions on the side walls of the first and second grill plates are shaped in a wavy configuration so that the concave portions of the first grill plate are matched with the concave portions of the second grill plate, so as to define a plurality of holes for allowing the holding ends of the skewers skewered with the foodstuffs to pass through and extend out of the electric grill, for preventing the holding end thereof from being heated or stained with oil leaked from the foodstuffs sandwiched between the first and second grill plates.

3. The electric grill with the skewer holders of claim 1, wherein both of the side walls of each of the first and second grill plates are formed with the concave portions for holding more skewers.
